(19) United States
(12) Patent Application Publication
(10) Pub. No.: US 2020/0327553 A1
(43) Pub. Date: Oct. 15, 2020

(54) POWER OUTAGE PARAMETRIC

(71) Applicant: MACHINE COVER, INC., Wenham, MA (US)

(72) Inventor: Inder-Jeet Singh GUJRAL, Wenham, MA (US)

(21) Appl. No.: 16/911,617

(22) Filed: Jun. 25, 2020

Related U.S. Application Data
(63) Continuation of application No. 16/857,213, filed on Apr. 24, 2020.
Application No. 16/857,213 is a continuation-in-part of application No. 16/430,547, filed on Jun. 4, 2019.
(60) Provisional application No. 62/680,032, filed on Jun. 4, 2018.

(51) Int. Cl. G06Q 30/00; G06Q 20/08; G06Q 40/08; G06Q 50/30; G06Q 10/06; G06Q 10/10

(52) U.S. Cl. CPC G06Q 30/012; G06Q 20/085; G06Q 40/08; G01P 5/00; G06Q 10/06312; G06Q 10/10; G06Q 50/30

(57) ABSTRACT

A parametric instrument is administered by defining a mishap for coverage by the parametric instrument, where the mishap is identifiable and verifiable after occurrence. The system determines when a trigger condition has taken place and confirms activation of the parametric instrument. This determination is practiced by measuring a triggered operating parameter and identifying and confirming when the triggered operating parameter satisfies predetermined trigger criteria. Activation of the parametric instrument is subsequently confirmed, and the corresponding benefit may be processed.

### CROSS-REFERENCES TO RELATED APPLICATIONS

This application is a continuation of U.S. patent application Ser. No. 16/857,213, filed Apr. 24, 2020, pending, which is a continuation-in-part of U.S. patent application Ser. No. 16/430,547, filed Jun. 4, 2019, which claims the benefit of U.S. Provisional Patent Application No. 62/680,032, filed Jun. 4, 2018, the entire contents of each of which are herein incorporated by reference.

### STATEMENT REGARDING FEDERALLY SPONSORED RESEARCH OR DEVELOPMENT

(NOT APPLICABLE)

### BACKGROUND AND SUMMARY

The invention relates to technology and parametric instruments and, more particularly, to systems and methods for developing and administering technology and parametric instruments.

Companies of all sizes rely on steady internet traffic for the success of their business. Interruptions in service, viruses, malicious attacks etc. can be costly as frustrated customers may seek alternative sources.

A technology “warranty” is a contract that promises its buyer that if they suffer a technological mishap, the contract holder will receive a benefit. The system and methods of the described embodiments enable technology warranties or instruments where the nature of the mishap is defined in advance, and the mechanism by which the occurrence of this mishap can be observed by any interested party is also defined in advance (in other words, the fact of whether the mishap has occurred is not disputable, and it may be verified externally and independently by any interested party). The benefit received by the buyer may be a predetermined sum of money or some other benefit.

Consider an example where such a technology warranty that costs $5,000/month, which is triggered by an impaired ability to support web traffic for the buyer of the instrument, and upon being triggered, pays $250,000, with the money for the payment coming from a risk partner.

The described embodiments are extendable beyond technology warranties to any parametric instrument where the nature of a mishap is defined in advance, and the mechanism by which the occurrence of this mishap can be observed by any interested party is also defined in advance (in other words, like the technology warranty, the fact of whether the mishap has occurred is not disputable, and it may be verified externally and independently by any interested party).

In an exemplary embodiment, a method of administering a parametric instrument includes the steps of (a) defining a mishap for coverage by the parametric instrument, the mishap being identifiable and verifiable after occurrence; (b) determining when a trigger condition has taken place for which the mishap is applicable and confirming activation of the parametric instrument, where the determining step is practiced by measuring a triggered operating parameter and identifying and confirming the trigger condition when the triggered operating parameter satisfies predetermined trigger criteria; and (c) after determining the trigger condition and confirming the activation of the parametric instrument, processing the corresponding benefit. The method may further include measuring a trigger experience; and defining a fee structure for the parametric instrument based on the trigger experience.

In some embodiments, the mishap is associated with weather, and the trigger condition is defined as a wind speed within a predefined distance from an address. In this context, the triggered operating parameter may be the wind speed being a specific defined value such as at least 85 mph. Measuring the trigger experience may include identifying historical wind speed data within the predefined distance from the address.

In some embodiments, the mishap is associated with air travel, and the trigger condition is defined as a flight's actual arrival time relative to the flight's scheduled arrival time. In this context, the triggered operating parameter may be the actual flight arrival time being a defined length of time (e.g., at least two hours) later than the flight's scheduled arrival time. Measuring the trigger experience may include identifying historical air travel data.

In some embodiments, the mishap is associated with power outages, and the trigger condition is defined as a power outage persisting for a defined time period, which for example, may be 24 hours. Measuring the trigger experience may include identifying historical power outage data.

The mishap may be associated with at least one of a covered Internet website, weather, air travel, power outages, movie production, and business regulations.

Step (b) may be practiced by performing a trigger scan to determine that the trigger condition has taken place and whether the triggered operating parameter is specific to the parametric instrument coverage.

In yet another exemplary embodiment, a method of administering a parametric instrument includes the steps of (a) defining a mishap for coverage by the parametric instrument, the mishap being identifiable and verifiable after occurrence; (b) determining when a trigger condition has taken place and confirming activation of the parametric instrument, where the determining step is practiced by measuring a triggered operating parameter, and identifying and confirming the trigger condition when the triggered operating parameter satisfies predetermined trigger criteria; and (c) after determining the trigger condition and confirming the activation of the parametric instrument, processing the corresponding benefit. Step (b) is practiced by performing a trigger scan to determine that the trigger condition has taken place, and step (c) is practiced by automatically paying the corresponding benefit without requiring a claim from the instrument purchaser.

### BRIEF DESCRIPTION OF THE DRAWINGS

These and other aspects and advantages will be described in detail with reference to the accompanying drawings, in which:

FIG. 1 is a flow diagram showing the methods of administering a technology/parametric instrument according to the described embodiments;

FIG. 2 is a flow diagram showing details of establishing baselines; and

FIG. 3 is a schematic illustration of a business model.

### DETAILED DESCRIPTION

A technology warranty is viable where the nature of the covered mishap is defined in advance, and the mechanism by which the occurrence of the mishap can be observed by any interested party is also defined in advance. That is, the fact of whether the mishap has occurred is not disputable, and it may be verified externally and independently by any interested party. A technology warranty thus protects companies from losses associated with technology aberrations resulting in a loss of business, connectivity, or the like.

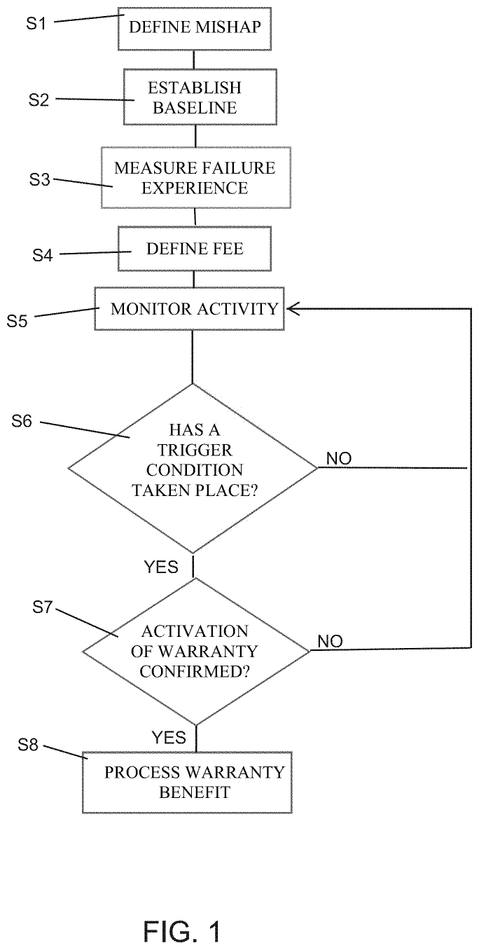

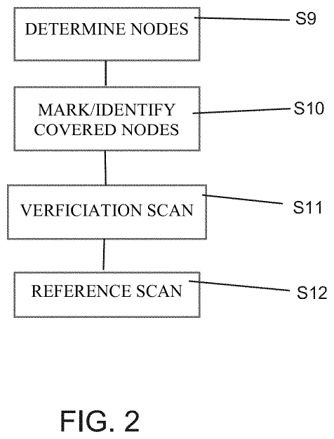

FIG. 1 is a flow diagram of the process for administering a technology warranty. Further details of the process steps are described below. In step S1, a mishap for coverage by the technology warranty is defined. As noted, the mishap should be identifiable and verifiable after occurrence. In some embodiments, the technology warranty may cover only one mishap, whatever its cause, where the warranty-holder's website either ceases to work at all, or if it does work, it serves web pages very sluggishly (the degree of ‘sluggishness’ is defined in a manner that is sufficient to trigger the warranty). A baseline operating parameter for which the mishap is applicable is established (S2). Details of the processes associated with establishing the baseline operating parameter will be described below with reference to FIG. 2.

In order to determine pricing for the technology warranty, a failure experience for the buyer and for the particular mishap is measured (S3), and a fee structure for the technology warranty can be defined based on the failure experience (S4). The failure experience or ‘impairment’ may be measured by asking the relevant website to serve a page, and it is determined whether the website cannot do so at all (in which case it is ‘down’) or it cannot do so within a defined amount of time (an exemplary threshold is that the first bytes of the requested page should show up within 15 seconds of the request being made).

In step S5, the buyer's website or other covered technology is monitored. Monitoring can be passive, where the warranty administrator receives a report of possible mishap occurrence from the warranty holder, or active, where the warranty administrator conducts a periodic analysis to determine a mishap occurrence. In some embodiments, the warranty administrator requests a page, and if the page is served with the defined threshold (e.g., 15 seconds), then the website is not impaired, otherwise, the website is impaired.

When a trigger condition has taken place (either reported by the warranty holder or detected by the warranty administrator) (YES in S6), activation of the technology warranty is confirmed (S7). In determining whether the trigger condition has taken place, a triggered operating parameter is compared with the baseline operating parameter, and the trigger condition is identified and confirmed when the triggered operating parameter satisfies predetermined trigger criteria (e.g., mishap, duration, limited to covered target, etc.). After determining the trigger condition and confirming the activation of the technology warranty, the warranty benefit is processed (S8).

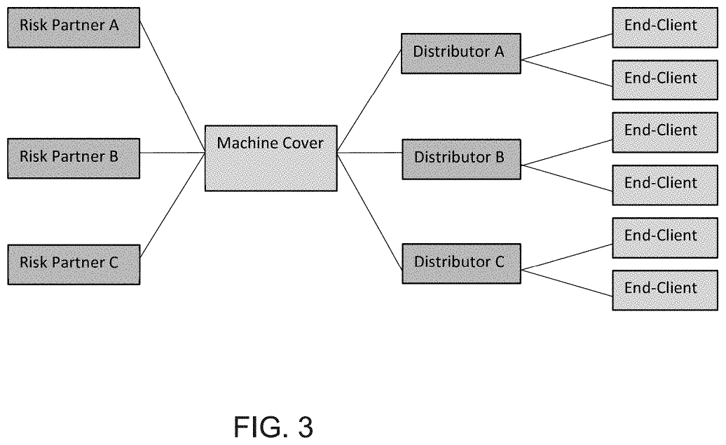

A warranty administrator defines and executes the warranties of all offered types with the support of the risk partners and the distributors. With reference to FIG. 3, the risk partners provide underwriting capacity. The exemplary model shows three such partners, but there may be 1 or 2 or N. A risk partner commits to the warranties in general, but this does not mean that they are legally bound to provide risk support for any specific warranty type—they may decline to cover the risk associated with it, while reserving the right to examine other warranty types for acceptance/rejection. Thus, a particular warranty type may be underwritten by a subset of all the risk partners.

In the most general case, a risk partner may commit a defined percentage of the payout for some warranty types but not others. Obviously a particular warranty type cannot be offered for sale unless 100% of its payout is covered by one or more risk partners.

Each distributor has a client base that may number in the hundreds or thousands. In all cases, the distributor already sells them technology-related products/services. A distributor may sell warranties to its clients by adding the warranty to the products or services it offers for sale, or by referring its clients to a warranty administrator.

A number of these distributors may be cyber-security companies that offer scans of their clients to determine traffic volume, infection, etc. Details of the scanning technology and process will thus not be further described. The cyber-security companies are thus also potentially providers of their scan technology to the warranty administrator. Thus, in the most general case, a distributor may be engaged with the warranty distributor in some or all of the following ways:
1. They sell the warranty administrator's warranties to their clients.
2. They refer their clients to the warranty administrator for the sale of warranties.
3. They license a ‘lite’ version of their scans to the warranty administrator for use in monitoring warranties.
4. Each warranty buyer being scanned using their ‘lite’ scans by the warranty administrator automatically becomes an upsell target for them to sell a ‘pro’ version of their services.

There is no reason why a provider of scans should also be a distributor, but given that most such companies have developed their scanning technology for sale to clients, it makes sense that if a company has both scan technology and clients, the warranty administrator could seek to engage with them as a distributor and also as a scan provider.

End clients are any entities that are exposed to cyber-risk or other technology risk.

Warranty types may be canned or custom. A canned warranty is one where the warranty administrator determines that there is a relatively universal problem that requires a general-purpose warranty and this warranty may be sold through multiple distributors/channels. However, coming up with such a warranty requires that the warranty administrator should come up with pricing, payouts and trigger conditions. An exemplary canned warranty covers a sharp drop in web traffic, wherein if the warranty holder pays $4K per month and if the agreed-upon mishap happens, the warranty administrator pay the warranty holder a fixed sum. Such a warranty can be offered via multiple distributors.

A custom warranty is where a distributor has a large number of clients and a specific externally-observable condition they would like to warrant against. In that case the design of the warranty (the price, the risk profile, the payout, etc.) would occur on a custom basis. A custom warranty offers a benefit that is specific to the end-clients of a given distributor and where the pricing of the warranty therefore depends on the historical experience of that distributor.

The general approach to warranty-pricing is to follow one of the following methods:
1. For canned warranties, the risk-partner(s) and the warranty administrator will model the warranty and agree upon a ‘base’ price as well as how this price will be split. This warranty will then be offered to all relevant distributors, with the expectation that the distributor will mark it up to whatever they think the market will bear. For example, a minimum may be 15% to bring it roughly on par with what a broker might get, but ultimately it is up to the distributor how to maximize revenue from the warranty.
2. For custom warranties, the risk-partner(s), the warranty administrator and the distributor will jointly model and agree upon the structure of the warranty, including a ‘base price’ which is what the distributor would be charged. The split between the risk-partner(s) and the warranty administrator will also be agreed upon. Once that is done, the distributor is free to mark it up as they want, as outlined in the previous example.

Determining the price for any warranty type will be described with reference to an example wherein a distributor detects malware and removes it when detected. The distributor may say “we find that in any given month, an average of 0.3% of our end-clients are found to be infected.” If they want to warrant against such infection, and they have a good sense of a ‘reasonable’ payout, the warranty administrator can calculate the long-run average aggregate payout per month, which can be used to arrive at a ‘floor’ price, i.e., one where the risk partner is highly unlikely to suffer a loss. For example, if we observe that 1% of websites are impaired each year, then if the warranty administrator charges any number more than 1% of the payout amount for impairment, that charge is guaranteed to at least meet the payout needs. This is defined as the minimum-necessary base price.

The warranty administrator acts as the intermediary between warranty distributors on the one hand, and providers of underwriting capacity on the other.

Specifically, the warranty administrator contributes as follows:
1. Distributors—it identifies and contracts with warranty distributors for both insurance as well as non-insurance channels.
A. Non-insurance brokers that provide technological products and/or services to the warranty buyers.
B. Insurance brokers are able to sell cyber-warranties as smaller versions of full cyber-policies for smaller companies, and also as cover for ‘the first million’ in larger cyber-policies. They are also able to sell warranties and then ‘upsell’ the client on full cyber-policies.
2. Studio—it offers a web-based software tool called the ‘studio’ which enables warranties to be defined and managed. In summary, defining a warranty means:
A. Modeling and then defining its price (i.e. its monthly fee) based on the failure experience of the distributor.
B. Modeling and then defining its payout (what the warranty-buyer gets if the warranty ‘triggers’) based on a range of numbers that is not so low as to be useless and not so high as to encourage fraud.
C. Defining the ‘trigger condition’ that causes the payout to be made.
3. Scans/Feeds—the scans/feeds that identify the initial condition of the domain/servers to which the warranty is to apply, that identify changes in them, and that monitor for the existence of the trigger condition. These are all available from numerous third party companies, but the warranty administrator can plug them all into a standard API so that even if a given warranty switches from scan A to B, the rest of the process is not affected.
4. Lifecycle Management—the series of transactions that occur during the lifecycle of any warranty—its initiation, its termination, the setting of its price, its auto-renewal with a (possibly) different price and so on, are all managed by the warranty administrator.
5. Risk partners—the warranty administrator arranges to ‘place’ each warranty type with one or more risk-capital partners by working out an agreed-upon price, negotiating the part of the warranty fee that each such partner will receive, etc.

Exemplary canned warranties may include:
1. WEB—a dramatic fall in web traffic. Most relevant to e-commerce sites where revenue is directly tied to such traffic, although also relevant to non-transactional websites since no one wants to see far fewer visitors for any reason.
A. Pricing—based on the frequency of web-wide ‘failures’.
B. Payout—warranty options may include three separate warranties with payouts of $250K, $500K and $1 million, respectively.
C. Trigger—the relevant network exhibits traffic drops in the range of 75% to 99% below the corresponding normalcy figure for a period of at least 24 hours.
2. DOS—a dramatic fall in ‘effective latency’ even though there may be a rise in web traffic, as illustrated by a DOS attack.
A. Pricing—based on the frequency of web-wide DOS attacks.
B. Payout—warranty options may include three separate warranties with payouts of $250K, $500K and $1 million, respectively.
C. Trigger—the relevant effective latency becomes at least 5× worse than the corresponding normalcy figure for a period of at least four hours.
3. IPP—a dramatic fall in Internet Protocol (IP)-packet traffic. Relevant for the health of Internet-connected networks that may not necessarily be related to web applications.
A. Pricing—based on the frequency of Internet-wide IP-traffic drops.
B. Payout—warranty options may include three separate warranties with payouts of $250K, $500K and $1 million, respectively.
C. Trigger—the relevant effective latency becomes at least 5× worse than the corresponding normalcy figure for a period of at least four hours.

The examples above, and their details, are merely illustrative.

Examples of custom warranties include:
1. SGX—specific to a particular cyber-security firm. By way of example, assume that this cyber-security firm keeps its client safe(r) by detecting malware signatures on their machines. This is a warranty that pays out if a known signature is detected despite this firm's best efforts. Pricing can be determined with reference to this firm's historical experience with its client base.
A. Pricing—based on this firm's experience of ‘failures’.
B. Payout—warranty options may include three separate warranties with payouts of $250K, $500K and $1 million, respectively.
C. Trigger—the relevant network exhibits traffic drops in the range of 75% to 99% below the corresponding normalcy figure for a period of at least 24 hours.
2. SLX—specific to a particular hosting firm. By way of example, assume this firm offers an SLA (service level agreement) to its clients. When/if the SLA fails, the ‘penalty’ is usually something like ‘free service for N months.’ For the client, however, the prospect of free service may not be very interesting since they may have lost 1000 times as much revenue during the outage. Hence the need for an SLA warranty that pays significant dollars.
A. Pricing—based on the frequency of SLA failures at this firm.
B. Payout—warranty options may include three separate warranties with payouts of $250K, $500K and $1 million, respectively.
C. Trigger—there is an SLA outage lasting more than 1 hour.

The examples above, and their details, are merely illustrative.

Warranty types that have been approved by risk partners up to a level of 100% underwriting support can be prepared for sale by the warranty administrator. A warranty type that has been prepared for sale includes the following:
It has a complete price stack (e.g., basic price, multiple-unit discount, best-practices factor and so on) as well as the underlying logic for those prices.
It has a defined trigger condition.
It has a defined payout.
It has a defined coverage period.
It cannot be sold before a specific date.

With reference to FIG. 2, the baseline operating parameters are established with a series of scans, including:

Inventory Scan (S9)—at least one scan will be performed which establishes the buyer's inventory. The warranty administrator needs to determine which ‘nodes’ (e.g. servers) are covered by the warranty and which are not. This is because, if the warranty covers some type of failure of a node, then the probability of failure rises with the number of nodes. The covered nodes may be ‘marked’ using suitable markers (e.g., token, interactive function, external recognition, etc.) (S10).

Verification Scan (S11)—at least one scan will be performed which establishes ‘best practices’, e.g. version of operating system running and security patches that are applied or not applied. For each covered node, the warranty administrator needs to determine whether that node is already doing best practices. For example, a server is running some specific OS version. Maybe it is new, maybe not. Maybe they have applied a range of security patches, maybe not. Depending on the nature of the warranty, what constitutes ‘best practices’ may vary.

Reference Scan (S12)—at least one scan will be performed that establishes ‘normalcy’ or baseline operating parameters. If the warranty says that it triggers due to an 80% drop below normal, for example, this scan determines normalcy for both the to-be-warranted target as well as a plurality of reference targets (e.g., 100 reference targets). ‘Normal’ may vary by time of day as well as day of week, so the warranty administrator needs to look for the reference ‘pattern’ rather than a reference ‘number’. Note that if the warranty administrator runs this scan over a longer period of time, e.g., seven days, the warranty administrator can determine variation by time of day and day of week, but not time of year, which may be highly relevant to (for example) sites that depend on holiday traffic.

Trigger Scan (S6 in FIG. 1)—at least one scan will be performed that determines if the trigger condition has fired or not. It is desirable to avoid the following scenarios during the trigger of a warranty:
1. A deviation from normalcy that is not ‘dramatic’.
2. An event that does not last long enough to be meaningful,
3. An event that is specific to the target rather than general in the sense of a widespread attack/outage—so we avoid systemic risk.

Thus the trigger definition and the objective of the trigger scan, should contain at least the following types of clauses:
1. A definition of deviation that is truly dramatic (e.g. web traffic drops by 85%).
2. The deviation lasts for a meaningful time (e.g. web traffic drops over at least 24 hours)
3. The warranty administrator tracks multiple reference sites and the problem is seen to be more or less unique to the warranted target, and not an across-the-board problem which would suggest a major outage or state-sponsored attack or similar.

The process of selling a warranty is accomplished through any of the following methods:
1. Referral—here the distributor only ‘refers’ end-clients to the warranty administrator website where the relevant warranty is available for sale.
2. Embedded Distribution—here the distributor embeds the warranty administrator-provided capability into its own website, such that the end-clients of this distributor can buy a warranty.
3. API Distribution—here the distributor uses the warranty administrator-provided distribution API to build its own warranty-sale UI for use in its own website.

The assumption is that the same API in (3) above, is also used to offer (1) and (2) above.

### Lifecycle

INTEREST—A potential buyer expresses interest in buying a warranty of some type. This is expressed, for example, by going to a relevant website and arriving at a point where detailed information about that warranty type is available and a rough price range is available, and a GET PRICE button or the like is selected to initiate the purchase process. (“GET PRICE” basically implies that while a rough price range is available, it is not possible to quote an exact price for a warranty until the warranty administrator examines the items the buyer wants covered by the warranty).

GET PRICE—If the user clicks the GET PRICE button, the warranty administrator asks the buyer to provide one or more domains or IP addresses or similar and offers a free-of-charge ‘introductory scan’ to the buyer. If the buyer enters the information and provides permission to proceed, the warranty administrator performs the introductory scan (specifically, the inventory and verification scans), which identifies the following:
Which nodes will be covered by the warranty
Which operating system and version is running on each node
Based on the previous point, which patches, security or otherwise, have been applied
Based on this, an exact price can be determined
The warranty administrator also checks whether this buyer and/or these nodes are already covered by some other warranty, or were covered in the past.

EXACT PRICE—The results of the introductory scan including the exact price are provided to the buyer and the buyer is provided an opportunity to buy the warranty. The buyer may be told the following:
Any purchased warranty will perpetually auto-renew unless cancelled, immediately upon ending of the previous warranty, so the buyer is never not covered.
The buyer will always be informed in advance of renewal, what the terms/price of the renewal are.
In any case, the buyer can always log into the appropriate web page and see the current status of the warranty and modify/cancel it if so desired.
The warranty preferably only covers ONE (1) firing of the trigger condition during any coverage period (multi-fire warranties may be available at some price premium). If the warranty fires, it is auto-renewed but at a possibly different price.
Although they can buy the warranty right away and although it covers a period of 30 days, its coverage will not start right away. In fact, the start of coverage may depend on two things:
1. Receipt of the warranty fee by the warranty provider, and
2. Completion of the reference scan (for which a promised done-by date/time is provided) and its acceptance by the buyer.

PURCHASE—The buyer buys the warranty. The reference scan starts. Once it ends, and assuming the warranty fee has been received, the buyer is provided with the results and invited to accept them. If the buyer chooses to reject them, the warranty fee is returned, less the cost of the scan if any. If the buyer chooses to accept them, the warranty coverage period begins and will run for a specified time, e.g., 30 days.

COVERAGE PERIOD START—Throughout the coverage period, the trigger scan may be run to check if the trigger condition fired or not (active monitoring). If it did not fire during the coverage period, then nothing happens, and the trigger scan ends when the coverage period ends. If it fired, then the PAYOUT process starts.

COVERAGE PERIOD END—at the end of any coverage period, the warranty is internally converted from ‘ACTIVE’ to ‘OLD’ i.e., it becomes of historical interest, but is no longer in effect. The warranty administrator can provide the buyer with the results of the reference and trigger scans so that they can see the patterns, even if nothing triggered.

CANCELLATION—At any point, the buyer can cancel the service, but in a preferred embodiment, they are only cancelling the renewals. That is, preferably, any warranty period, once begun, cannot be cancelled. Once a warranty is cancelled, there is no reinstatement, i.e., a new warranty can of course be purchased but it may not take advantage of any of the work done for any previous warranty.

RENEWAL—Assuming that it takes N days to run the reference scan and a few minutes to run the inventory and verification scans, then N+1 or N+2 days before any existing warranty is scheduled to end, the inventory and verification scans are run to check if something has changed on the covered nodes compared to the last time they were run. Once the exact price is determined, the buyer is informed that the warranty will renew at the new price, immediately upon the end of the current warranty.

PAYOUT—if the trigger condition fires, the relevant risk partners are promptly informed and the payout is made and tracked. Furthermore, and automatically, the warranty immediately expires, and if the system is able to support the sale of one more warranty of this type, then the expired warranty is replaced by another warranty that covers the period remaining in the original warranty, and the (possibly higher) fee for this new warranty is deducted from the payout before the payout is sent to the beneficiary. The new warranty kicks in only if the trigger-fire condition has been ‘fixed’.

Some examples of distributors through which such warranties can be sold, are provided below. In most cases, the distributor sells the warranty as an ‘add-on sale’, i.e., they already sell products/services to their clients, and may sell one or more warranties to the same clients, often as items that add value to what they already sell.
1. Hosting Providers, Cloud Providers, Managed-Cloud Companies: Warranties may be purchased by clients of these companies, e.g., a client might buy a warranty which says that if this client's computing resources are misused in defined ways, a payout is triggered.
2. Cyber-Security Companies: these companies normally sell products and services intended to sharply reduce the odds of ‘bad things’ happening to their clients. They can sell warranties as companions for the products/services they normally sell, and if despite their best efforts a defined ‘bad thing’ does happen at one of their clients, a payout is triggered.
3. System Integrators: these companies are hired to alter their client's IT resources/configuration and inevitably, the first few months of any such project are likely destabilizing, with the consequent need for warranties.

The systems and methodology of the technology warranties are equally applicable to more general “parametric” instruments. For example, consider a weather instrument. The U.S. Government has records on local weather within the U.S. since 1949 through over 1600 weather stations (mainly at small airports and mainly for civil aviation purposes). Each weather station measures wind speed, wind direction, snowfall, overall precipitation etc. every few minutes. Analyzing this data and coordinating it with publicly available map data, the result can be run through an artificial intelligence (AI) algorithm in order to estimate the wind-speed probability distribution for each weather station. There are several known AI platforms suitable for analyzing and coordinating the data. An exemplary platform is the SageMaker platform from AWS (Amazon Web Services). The use and functionality of the SageMaker platform are described at http://docs.aws.amazon.com/segemaker/latest/dg/how-it-works-mlconcepts.html, the content of which is hereby incorporated by reference.

These estimates lead to an offer relating to a weather instrument. Conceptually, if the purchaser owns a building somewhere in the U.S. (generally a residential home), if the wind speed within N miles of this building (e.g. at the nearest weather station) exceeds M mph, the parametric instrument will pay $X, no questions asked. An exemplary value for wind speed may be 85 mph or higher.

Recognizing that homeowners typically purchase an indemnity-type homeowner insurance policy for their house, if a storm blows through, however, it may cause problems for the homeowner that aren't covered by traditional insurance if the house itself is not damaged. For example, a tree might get knocked over and block the driveway, the nearby daycare center or elementary school might be damaged, the family might need to go to a hotel nearby, etc. All of these cost money, and the homeowner may not have a few thousand dollars saved up for use at times like these.

Like the technology warranty, because the mishap is objectively identifiable and verifiable after occurrence, there is no dispute or claims adjusters, etc. The process can be completely automated and administered via a browser on a desktop or a mobile phone or the like. With reference to FIG. 1, step S1 in this embodiment is associated with weather. The baseline in step S2 may not be required in the general parametric application as such baselines may be inherent in the mishap. In this embodiment, wind speed is either below the threshold or above it. In step S3, “failure experience” refers to historical data of wind speed occurrences above the threshold. The failure experience enables the system to make an objective determination of the chances that trigger condition will take place, and with these chances calculated, the fee for the product can be determined (step S4). Steps S5-S8 are similarly processed by monitoring wind speed (S6), confirming activation of the instrument in the event the wind speed exceeds the predefined wind speed within the predefined distance from the address (S7), and processing the benefit (S8).

In this example, it is desirable for the instrument purchaser to own the building or otherwise have an interest in the building for which the weather instrument is obtained. This prevents ‘gambling’ or gaming the system.

As noted, there is no concept of ‘loss’ here—the building may or may not be damaged—but there may be expenses nonetheless, and it is hard to predict what they might be. Instrument holders are not required to file any paperwork or first-notice-of-loss or claim or receipts or anything else. The system can monitor each weather station in the U.S., and if the wind speed exceeds the stated amount, the instrument holder is provided a notice, and the benefit is processed. The system can automatically place the money in the instrument holder's bank account, credit card, Paypal, etc.

Moreover, there is no ‘rating calculation’ to file. The instrument purchaser simply identifies the address of the house. The purchaser also pays a fixed cost. If high winds occur in the area, the system pays the purchaser a fixed amount of money. There is no multi-page insurance policy. Instead, there is a one-page legal agreement that basically says—you bought a weather instrument 123 Main Street, Somewhereville Mass. 12345. If the system detects winds exceeding M mph nearby (e.g., within N miles of the registered address), then the instrument provider owes the instrument purchaser a predefined payout. Of course, the weather instrument would not in any way affect the homeowner policy if one exists.

As another example, consider an air travel instrument. The Federal Aviation Administration has maintained records on all commercial passenger flights within the U.S. since 1989—a total of about 200 million flights. In any given year, roughly seven million flights occur. Analyzing this data and coordinating it with publicly available data about weather, aircraft types, airlines, times of day, days of week, seasons of year etc., the result can be run through an AI algorithm in order to estimate the delay probabilities of each specific flight. The net result is that the average probability that any flight in the U.S. will be, for example, 2+ hours late (i.e., it will arrive at its gate 2+ hours after it was supposed to) is around 2.2%. Different percentages would of course result with different parameters.

On this exemplary parameter, an air travel instrument may provide a payout for any flight that is 2+ hours late (or some other defined period of time). In some embodiments, if the flight is 2+ hours late, the instrument coverage we will refund the cost of the traveler's ticket. The benefit can help the traveler deal with the single biggest pain-point related to air travel—delays, missed connections, missed meetings etc.

The product requires that the instrument purchaser has purchased a ticket, which can be verified by the airline six-character record locator. This prevents gaming the system. There is no concept of ‘loss’ here—as passengers still get to where they wanted to go. The passengers simply arrived later than planned, which may lead to annoyance (but not necessarily a monetary loss). Like the other described products, there is no paperwork or first-notice-of-loss or claim or receipts or anything else to prepare or submit. Rather, the system monitors each flight in the U.S., and if it lands sufficiently late, the instrument purchaser receives an email or text that says, “your flight landed late, so we owe you money . . . ,” and the system processes the instrument payout.

There is similarly no ‘rating calculation’ to file. The passenger identifies their flight, and the system tracks that flight. The passenger also pays a fixed amount. If the flight arrives more than the defined time period late (e.g., 2+ hours) at its destination gate, the passenger is paid a fixed payout.

With reference to FIG. 1, step S1 in this embodiment is associated with air travel. The baseline is pre-established as the instrument purchaser's flight arrives either before the time period window or after it. In step S3, “failure experience” refers to historical data of flights arriving more than the time period window (e.g., 2+ hours) after their scheduled arrival time. The failure experience enables the system to make an objective determination of the chances that trigger condition will take place, and with these chances calculated, the fee for the product can be determined (step S4). Steps S5-S8 are similarly processed by monitoring flight status (S6), confirming activation of the instrument in the event the flight arrives more than the defined time period after the scheduled arrival time, and processing the benefit (S8).

There is similarly no multi-page insurance policy. Instead, there is a one-page legal agreement that basically says the purchaser purchased an air travel instrument for AIRLINE Flight XYZ from place A to place B. It is supposed to arrive at time T1. If this flight arrives at any time after T2 (i.e., some defined length of time after T1), then the instrument payout will be processed/paid.

As another example, consider a power outage instrument via an electric utility. Assuming the electric utility supplies one million households and 67,000 businesses. None of the households or businesses is currently insured against a power outage specifically. At best, a ‘business interruption’ may be included in a commercial policy that may have been purchased by some of these businesses. Meanwhile, the utility has data on outages per customer, particularly if they utilize ‘smart meters’.

Exemplary products may include three products offered to these 1.067 million electricity customers (the numbers below are exemplary):
(a) For households, an exemplary offer may be that for a payment of $1.95 per month on your utility bill or on a credit card or the like, if the household power goes out for more than 24 hours, the benefit/payout is $2000 payable to the account/instrument holder via check or via a credit on the utility account or some equivalent;
(b) For businesses, an exemplary offer may be for $25 per month, if the business power goes out for more than 24 hours, the benefit/payout is $25,000; and
(c) a ‘Fridge-Hedge’ product aimed at businesses that keep products in refrigerators and freezers (e.g., food, medicines, etc.) and that are required by law to discard everything in their cold storage upon loss of cooling for N hours, where N is differently defined in different places and for different applications.

Like the technology warranty, because the mishap is objectively identifiable and verifiable after occurrence, there is no dispute or claims adjusters, etc. With reference to FIG. 1, step S1 in this embodiment is associated with a power outage. The baseline in step S2 may not be required in the general parametric application as such baselines may be inherent in the mishap. In this embodiment, the baseline includes the fact that the power outage took place and that the outage lasted for a preset time period (e.g., 24 hours or longer). In step S3, “failure experience” refers to historical data of power outages that lasted for the preset time period. The failure experience enables the system to make an objective determination of the chances that trigger condition will take place, and with these chances calculated, the fee for the product can be determined (step S4). Steps S5-S8 are similarly processed by monitoring power outages (S6), confirming activation of the instrument in the event a power outage lasts longer than the preset time period (S7), and processing the corresponding benefit (S8).

The process can be 100% automated, as the customer is already paying a monthly bill to the electric utility, and the price of the offering is easily determined based on the years of outage data possessed by the utilities.

The instrument can be distributed as an ‘add-on service instrument’ to any household or business that buys power from the utility. Of course the same products could also be sold via insurance channels (e.g. as add-ons to homeowner insurance policies).

The products are desirable in that if a homeowner suffers a power outage lasting for example 24 hours, everything in the freezer may have to be discarded or computer data may be lost, or a host of other potential problems may occur. If a business owner suffers a power outage, the business would lose heating/cooling/lights, preventing customers from coming, rendering in-office machines inoperable, requiring all employees to go home, etc. In either case, getting the proposed benefit would be an immense help. Also, neither adverse selection nor moral hazard apply, since the price of the product is generated online and depends on the historical outage probability for that customer, and the payouts are small enough not to be ‘windfalls’.

Another exemplary parametric instrument may be associated with movie production. A movie studio has spent $50 million creating a movie containing star A. Between the time that the movie is completed (i.e., the money is spent) and it is released, star A does something that draws unwelcome attention and causes the studio to ‘pull’ the movie (e.g. sexual assault rumors—rumors mind you, not conviction or exoneration in a court of law). The studio might purchase a ‘disgrace parametric’ instrument, which pays the studio if (say) 80% of tweets about A are negative.

Another exemplary parametric instrument may be associated with business regulations. Small-company A is subject to a number of state and federal regulations. Consider regulation B. It applies to 100,000 businesses, and the regulator audits compliance at random in 137 of these companies in any given year. If A is audited, there is no warning and A ends up spending (say) $15K on legal fees, consulting fees etc., regardless of whether it is eventually found compliant or in default. Company A might buy a “regulation-parametric” instrument which pays $15,000 where the trigger is written (e.g. letter, email) proof of an audit.

The parametric instrument is applicable to any “mishap” that is identifiable and verifiable after occurrence, where the chances of occurrence can be reasonable estimated. In all these cases, the parametric may be regulated as an insurance product or as a instrument or as something else—but that does not affect the basic design of the mechanism nor the technology needed to implement it.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of administering a parametric instrument, the method comprising:
(a) defining a mishap for coverage by the parametric instrument, the mishap being identifiable and verifiable after occurrence;
(b) determining when a trigger condition has taken place for which the mishap is applicable and confirming activation of the parametric instrument, the determining step being practiced by measuring a triggered operating parameter and identifying and confirming the trigger condition when the triggered operating parameter satisfies predetermined trigger criteria;
(c) after determining the trigger condition and confirming the activation of the parametric warranty, processing a corresponding benefit,
wherein the mishap is associated with power outages, and wherein the trigger condition is defined as a power outage persisting for a preset time period.

2. A method according to claim 1, wherein the preset time period is 24 hours.

3. A method according to claim 1, further comprising:
measuring a trigger experience; and
defining a fee structure for the parametric instrument based on the trigger experience.

4. A method according to claim 3, wherein measuring the trigger experience comprises identifying historical power outage data.

5. A method according to claim 1, wherein step (b) is practiced by performing a trigger scan to determine that the trigger condition has taken place and whether the triggered operating parameter is specific to the parametric instrument coverage.

6. A method according to claim 1, wherein the mishap is associated with businesses that keep products in refrigerators or freezers, and wherein the preset time period is determined based on laws associated with the products.

7. A method according to claim 1, wherein steps (a)-(c) are 100% automated.

8. A method according to claim 1, further comprising distributing the instrument as an add-on component to a household or business utility account.

9. A method according to claim 8, further comprising distributing the instrument as an add-on component to a homeowner or business insurance policy.

10. A method of administering a parametric instrument, the method comprising:
(a) defining a mishap for coverage by the parametric instrument, the mishap being identifiable and verifiable after occurrence;
(b) determining when a trigger condition has taken place and confirming activation of the parametric instrument, the determining step being practiced by measuring a triggered operating parameter, and identifying and confirming the trigger condition when the triggered operating parameter satisfies predetermined trigger criteria; and
(c) after determining the trigger condition and confirming the activation of the parametric instrument, processing a corresponding benefit,
wherein step (b) is practiced by performing a trigger scan to determine that the trigger condition has taken place, and wherein step (c) is practiced by automatically paying the corresponding benefit without requiring a claim from an instrument purchaser,
wherein the mishap is associated with power outages, and wherein the trigger condition is defined as a power outage persisting for a preset time period.

11. A method according to claim 10, wherein the preset time period is 24 hours.

12. A method according to claim 10, further comprising:
measuring a trigger experience by identifying historical power outage data; and
defining a fee structure for the parametric instrument based on the trigger experience.

13. A method according to claim 10, wherein the mishap is associated with businesses that keep products in refrigerators or freezers, and wherein the preset time period is determined based on laws associated with the products.

14. A method according to claim 1, wherein steps (a)-(c) are 100% automated.
